(19) United States
(12) Patent Application Publication
(10) Pub. No.: US 2007/0243835 A1
(43) Pub. Date: Oct. 18, 2007

(54) ENHANCED PUSH-TO-TALK BUTTON INTEGRATING HAPTIC RESPONSE

(75) Inventors: Xiaofeng Zhu, Nanjing, Jiangsu (CN); Hangying Mao, Nanjing, Jiangsu (CN); Luis A. Pichardo, Miramar, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc., Schaumburg, IL (US)

(21) Appl. No.: 11/279,623

(22) Filed: Apr. 13, 2006

(51) Int. Cl. H04B 1/38

(52) U.S. Cl. 455/90.2

(57) ABSTRACT

A mobile station (100) that includes a push-to-talk (PTT) button (150) and a haptic response system directly connected to the PTT button. The haptic response system can include a positional actuator (170) and a haptic controller (160) operatively coupled to the positional actuator. The haptic response system also can include a vibration generator (175). The haptic controller can be operatively coupled to the vibration generator. The mobile station also can include an indicator lamp (185) and/or touch sensor (195) integrated into the PTT button.

### BACKGROUND OF THE INVENTION

1. Field of the Invention

The present invention generally relates to mobile communications and, more particularly, to mobile stations that include push-to-talk functionality.

### BACKGROUND OF THE INVENTION

Push-to-talk (PTT) is a popular feature often provided on mobile stations. PTT provides a means of conversing on half-duplex communication lines, including two-way radio, using a PTT button to switch from voice transmission mode to voice reception mode.

The PTT button typically consists of a simple switch that is integrated into the mobile station. When the PTT button is pressed, an audible status tone is provided to indicate the status of the mobile station. After being alerted to the mobile station status, a user can select his next action, for instance to talk, listen, wait, retry, etc. The audible status tone oftentimes is heard by others, however, who are not involved in the conversation.

### SUMMARY OF THE INVENTION

The present invention relates to a mobile station that includes a push-to-talk (PTT) button and a haptic response system directly connected to the PTT button. The haptic response system can include a positional actuator and a haptic controller operatively coupled to the positional actuator. A force feedback amplifier can be operatively coupled between haptic controller and the positional actuator.

The haptic response system also can include a vibration generator. The haptic controller can be operatively coupled to the vibration generator. A vibration amplifier can be operatively coupled between haptic controller and the vibration generator.

The mobile station also can include a touch sensor integrated into the PTT button. The touch sensor can signal the mobile station to disable audible status tones in response to detecting an appendage in contact with the PTT button. The touch sensor also can signal the mobile station to disable the haptic response system in response to detecting that an appendage is not in contact with the PTT button.

Further, the mobile station can include an indicator lamp integrated into the PTT button. An indicator lamp driver also can be included. The indicator lamp driver can be operatively coupled to the haptic response system.

The present invention also relates to a method for indicating a status of a mobile station. The method can include receiving a response to a dispatch call request and generating a haptic stimulus via a PTT button that correlates to the received response. For example, a translational force can be applied to the PTT button and/or the PTT button can be vibrated. The method also can include disabling mobile station audible status tones in response to detecting an appendage in contact with the PTT button. Further, the haptic stimulus can be disabled in response to detecting that an appendage is not in contact with the PTT button.

### BRIEF DESCRIPTION OF THE DRAWINGS

Preferred embodiments of the present invention will be described below in more detail, with reference to the accompanying drawings, in which:

FIG. 1 depicts a block diagram of a mobile station that is useful for understanding the present invention;

FIG. 2 depicts a push-to-talk button that is useful for understanding the present invention; and

FIG. 3 depicts call dispatch flow diagrams that are useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a mobile station that provides haptic feedback to a user via a push-to-talk (PTT) button. For example, the mobile station can include a force feedback system directly connected to the PTT button. The force feedback system can provide haptic stimulus by moving the PTT button and/or holding the PTT button in a particular position. A vibration generator can be integrated into the PTT button to provide haptic stimulus in the form of vibration. A variety of stimulus profiles can be provided, each of which conveys a different status or message to the user. The haptic stimulus can be provided in lieu of, or in addition to, audible status tones.

FIG. 1 depicts a block diagram of a mobile station 100 that is useful for understanding the present invention. The mobile station 100 can include a controller 105, a user input device, such as a keypad 110, a display 115, memory 120, a data processor 125, a transceiver 130, an audio processor 135, an input audio transducer 140 and/or an output audio transducer 145.

The mobile station 100 further can include a PTT button 150 and a button sensor 155. The button sensor 155 can sense whether the PTT button 150 is depressed and relay such information to the controller 105. The controller 105 can be configured to initiate various transmit/receive functions that correlate to the position of the button. For example, the controller 105 can signal the transceiver 130 to transmit communication signals when the PTT button 150 is depressed, and to standby to receive communication signals when the PTT button 150 is released.

The mobile station 100 also can include a haptic controller 160. The haptic controller 160 can comprise a central processing unit (CPU), a digital signal processor (DSP), an application specific integrated circuit (ASIC), a programmable logic device (PLD), a plurality of discrete components that cooperate to process data, and/or any other suitable processing device. In one arrangement, the haptic controller 160 can be integrated with the controller 105 on an integrated circuit.

The controller 105 can interface with the haptic controller 160 to trigger one or more haptic stimuli that depend on whether the PTT button 150 is currently depressed and/or the status of the mobile station 100. For example, the haptic controller 160 can be operatively coupled to a positional actuator 170. Further, a force feedback amplifier 165 can be operatively coupled between the haptic controller 160 and the positional actuator 170.

In operation, the haptic controller 160 can generate a signal, which can be amplified by the force feedback amplifier 165, that causes the positional actuator 170 to apply a translational force to the PTT button 150 (i.e. provide force feedback). The level of signal amplification provided by the force feedback amplifier 165 can be selectable so that the positional actuator 170 can achieve a desired level of translational force. The translational force can pull or hold the PTT button 150 in the depressed position, or push or hold the PTT button 150 in the released position. The translational force also can be alternated to alternately pull and push the PTT button 150.

A vibration generator 175 can be provided in lieu of, or in combination with, the positional actuator 170. The vibration generator 175 can be mechanically connected to the PTT button 150 in a manner which causes the PTT button 150 to vibrate when the vibration generator 175 is activated. For example, at least a portion of the vibration generator 175 can be positioned within the PTT button 150. The haptic controller 160 can be operatively coupled to the vibration generator 175. Further, a vibration amplifier 180 can be operatively coupled between the haptic controller 160 and the vibration generator 175. In one arrangement, rather than being separate components, the force feedback amplifier 165 and/or the vibration amplifier 180 can be integrated into the haptic controller 160.

In operation, the haptic controller 160 can generate a vibration signal, which is amplified by the vibration amplifier 180. The vibration signal can cause the vibration generator 175 to provide a vibration stimulus via the PTT button 150. The level of amplification provided by the vibration amplifier 180 can be selectable so that the vibration generator 175 can provide different levels of vibration.

The mobile station 100 also can include an indicator lamp 185. The indicator lamp 185 can be integrated into the PTT button 150, or provided elsewhere on the mobile station 100. The indicator lamp 185 can be a light emitting diode or any other suitable light emitting device.

An indicator lamp driver 190 can be operatively coupled to the indicator lamp 185. For example, the indicator lamp driver 190 can be operatively coupled between the haptic controller 160 and the indicator lamp 185. Alternatively, the indicator lamp driver 190 can be operatively coupled between the controller 105 and the indicator lamp 185. The indicator lamp driver 190 also can be integrated into the haptic controller 160 and/or the controller 105. In response to signals received from the haptic controller 160 and/or the controller 105, the indicator lamp driver 190 can apply signals to the indicator lamp 185 which cause the indicator lamp 185 to emit light in accordance with a selected pattern that correlates to the status of the mobile station 100.

A touch sensor 195 can be integrated into the PTT button 150. Touch sensors are known to the skilled artisan, and the touch sensor 195 can be implemented in any suitable manner. The touch sensor 195 can be operatively coupled to the controller 105. The touch sensor 195 can sense contact with the PTT button 150 to determine whether a user's appendage, for example a finger, is in contact with the PTT button 150 and communicate a correlating signal to the controller 105, thereby signaling the controller 105 to implement a suitable response.

When a signal received from the touch sensor 195 indicates that an appendage is not in contact with the PTT button 150, the controller 105 can enable audible status tones generated by the mobile station 1 00. For example, the controller 105 can signal the audio processor 135 to enable the audible status tones. The controller also can disable the haptic controller 160 when an appendage is not in contact with the PTT button 150, thereby disabling haptic responses.

When a signal received from the touch sensor 195 indicates that an appendage is in contact with the PTT button 150, the controller 105 can enable the haptic controller 160, thereby enabling the PTT button 150 haptic responses. The controller 105 also can signal the audio processor 135 to disable the audible status tones. Accordingly, the audible status tones can be automatically disabled when the user is prepared to receive haptic responses. Accordingly, others who are not involved in a conversation on the mobile station 100 can be prevented from hearing the audible status tones.

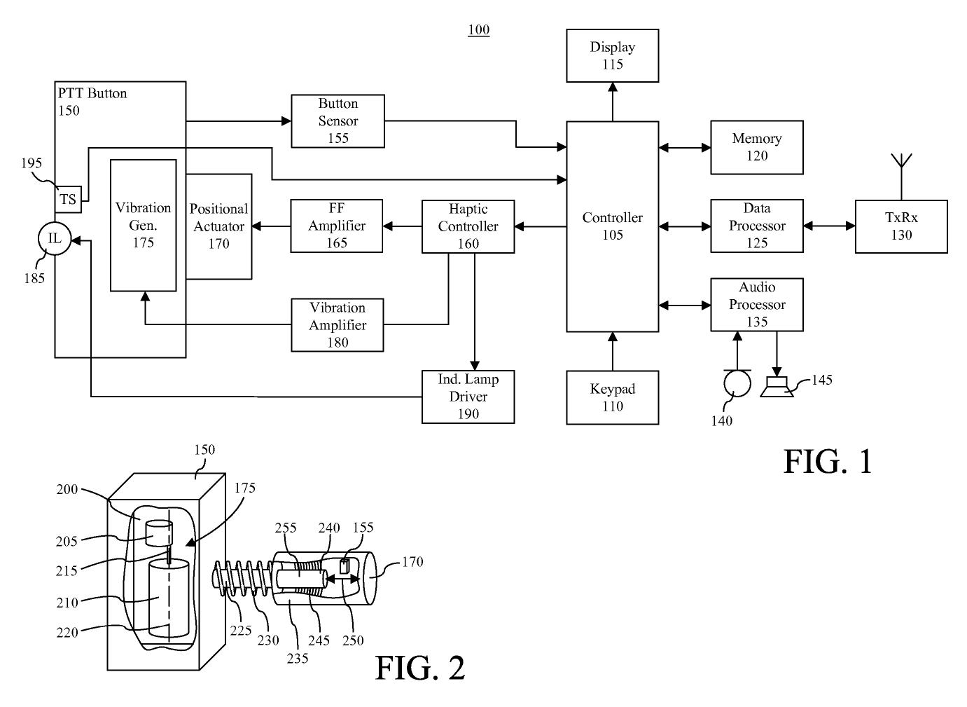

FIG. 2 depicts an example of the push-to-talk PTT button 150 that is useful for understanding the present invention. The vibration generator 175 can be directly connected to the PTT button 150. For example, the vibration generator 175 can be fixed within a cavity 200 defined in the PTT button 150. The vibration generator 175 can include a mass 205 that is connected to an electrical motor 210 via a shaft 215. The shaft 215 can connect to the mass 205 at a location on the mass 205 that is distal from the mass's center of gravity.

In operation, an electrical signal generated by the haptic controller and amplified by the vibration amplifier can be applied to the motor 210. The electrical signal can cause the shaft 215 to rotate, thereby rotating the mass 205 about an axis of rotation 220 defined by the shaft 215. Since the center of gravity of the mass 205 is offset from the axis of rotation 220, such rotation can cause the vibration generator 175, and hence the PTT button 150, to vibrate. The electrical signal can be applied at any of a number of various signal levels, thereby enabling different levels of vibration to be provided. For example, a low level vibration can indicate a status that is different than the status indicated by a high level of vibration. At this point it should be noted that the example depicted is but one arrangement and that the vibration generator 175 can be implemented in any other suitable manner.

The positional actuator 170 can include a shaft 225 that is connected to the PTT button 150. The shaft 225 can be glued to the PTT button 150, snapped to the PTT button 150 or directly connected to the PTT button 150 in any other suitable manner. A biasing member 230 can resiliently bias the PTT button 150 into a first position, for example an un-depressed, or out, position. The biasing member 230 can comprise a spring or a suitably resilient material. The biasing member 230 can be positioned between the PTT button 150 and the body 235 of the positional actuator 170, or positioned between the PTT button 150 and another component of the mobile station.

In one arrangement, the button sensor 155 can be integrated into the positional actuator 170. For example, the button sensor 155 can be positioned within the body 235 of the positional actuator 170. In such an arrangement, the button sensor 155 can detect whether the PTT button 150 is depressed by detecting a position of the shaft 225. For instance, the button sensor 155 can be configured to contact a portion 240 of the shaft 225 when the PTT button 150 is depressed. Alternatively, the button sensor 155 can detect whether the portion 240 of the shaft 225 is proximate to the button sensor 155. For example, button sensor 155 can optically or electromagnetically detect the position of the shaft 225. For instance, the button sensor 155 can be an optical sensor or a Hall effect sensor.

In yet another arrangement, the button sensor 155 can comprise a variable impedance device, such as a variable capacitor or a variable resistor. A switch slide arm (not shown) can be operatively connected between the shaft 225 and the variable impedance device so as to vary impedance of the variable impedance device when the shaft 225 moves, for example when the PTT button 150 is depressed or released. Still, the button sensor 155 can be implemented in any suitable manner and the invention is not limited in this regard.

The positional actuator 170 also can comprise an electromagnet 245. Electromagnets are known to the skilled artisan. In such an arrangement, at least a portion 255 of the shaft 225 can comprise a ferromagnetic material, or ferromagnetic material can be otherwise mechanically connected to the shaft 225. The force feedback amplifier can apply an electrical signal to the electromagnet 245 to generate a force on the shaft 225 to move the shaft 225 along an axis 250. The electromagnet 245 can be at least partially electromagnetically shielded from the button sensor 155 if the button sensor 155 is a Hall effect sensor or any other type of sensor that may be susceptible to the electromagnetic field generated by the electromagnet 245.

In an arrangement in which the electrical signal that is applied comprises direct current, the polarity of the direct signal can be selected to achieve a desired translational movement or to hold the PTT button 150 in a desired position. For example, a first polarity can be applied to move the PTT button 150 outward along the axis 250, and a second polarity can be applied to move the PTT button 150 inward along the axis 250. The selected polarity also can be applied to hold the PTT button 150 in a desired position. In one aspect of the invention, the electrical signal can be alternated between the first polarity and the second polarity to cause the PTT button 150 to vibrate along the axis 250, in which case the vibration generator 175 may not be required.

The level of electrical signal that is applied to the electromagnet 245 can be selectable. For example, a relatively low electrical signal can be applied to gently move the PTT button 150 and provide a small amount of force feedback, and a relatively high level of electrical signal can be applied to move the PTT button 150 with greater force, thus providing a higher amount of force feedback. In another arrangement, the electrical signal can be provided at a level that generates enough force to aid user in holding the PTT button 150 in the depressed position, but still allows the biasing member 230 to move the PTT button 150 outward when the user releases the PTT button 150.

Further, the position of the PTT button 150 can be considered when selecting the level of electrical signal that is applied. For example, the haptic controller 160 can comprise a servo control circuit for controlling the positional actuator 170. In such an arrangement, data received from the button sensor 155 can be forwarded to the haptic controller as control feedback. When force feedback is to be applied to the PTT button 150, the haptic controller can adjust the level of electrical signal to achieve a desired movement of the PTT button 150. Still, the level of electrical signal that is provided to the positional actuator 170 to control its movement can be selected in any other suitable manner and the invention is not limited in this regard.

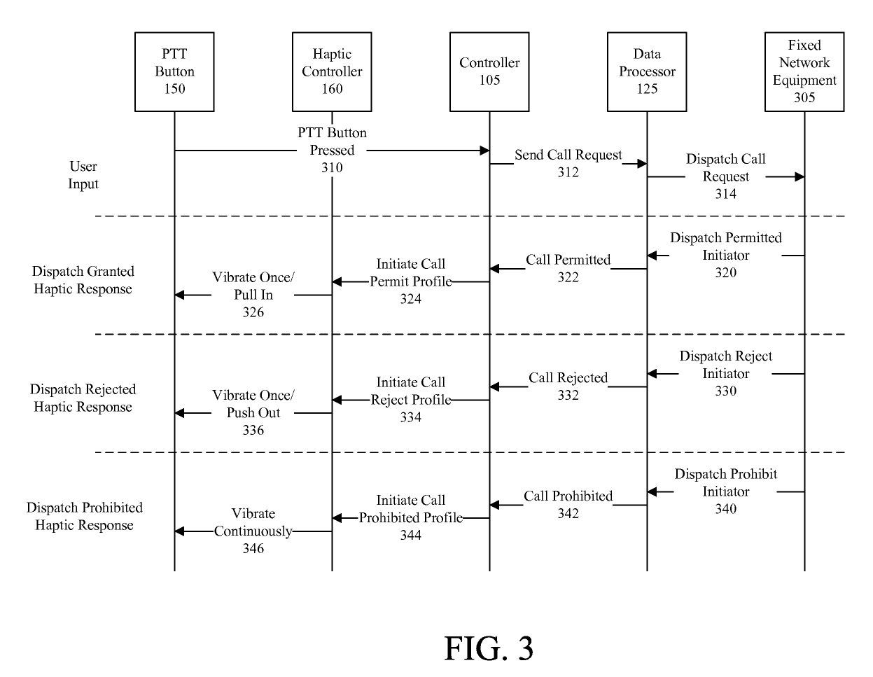

FIG. 3 depicts call dispatch flow diagrams that are useful for understanding the present invention. The haptic responses described with respect to FIG. 3 are presented for example purposes, but those skilled in the art will appreciate that a myriad of other haptic responses can be provided and the invention is not limited in this regard.

The call dispatch process can begin with a user input. At step 310, the PTT button 150 can be pressed and the controller 105 can receive a button pressed signal, for example from the button sensor. At step 312 the controller 105 can send a call request to the data processor 125. At step 314 the data processor 125 can dispatch the call request via the transceiver to fixed network equipment 305 in a communications network.

If the dispatch call request is permitted by the fixed network equipment 305, at step 320 a dispatch permitted initiator can be transmitted to the mobile station. The dispatch permitted initiator can be received by the transceiver of the mobile station and directed to the data processor 125. At step 322, in response to the dispatch permitted initiator, the data processor 125 can forward a call permitted signal to the controller 105. Proceeding to 324, the controller can signal the haptic controller 160 to initiate a call permit profile. Continuing to step 326, the haptic controller 160 can initiate a haptic response that signals to the user that the call has been permitted. For example, the haptic controller 160 can propagate signals to the force feedback amplifier that causes the PTT button 150 to vibrate once and then pull in. The PTT button 150 can be held in the depressed position for a defined time period, held while an appendage touching the PTT button 150 is detected by the touch sensor, or held while audio signals from a user are detected.

If the dispatch call request is rejected by the fixed network equipment 305, at step 330 a dispatch rejected initiator can be transmitted to the mobile station. The dispatch rejected initiator can be received by the transceiver of the mobile station and directed to the data processor 125. At step 332, in response to the dispatch rejected initiator, the data processor 125 can forward a call rejected signal to the controller 105. Proceeding to 334, the controller 105 can signal the haptic controller 160 to initiate a call rejected profile. Continuing to step 336, the haptic controller 160 can initiate a haptic response that signals to the user that the call has been rejected. For example, the haptic controller can propagate signals to the force feedback amplifier that causes the PTT button 150 to vibrate once and then push out.

If the dispatch call request is prohibited by the fixed network equipment 305, at step 340 a dispatch prohibited initiator can be transmitted to the mobile station. The dispatch prohibited initiator can be received by the transceiver of the mobile station and directed to the data processor 125. At step 342, in response to the dispatch prohibited initiator, the data processor 125 can forward a call prohibited signal to the controller 105. Proceeding to 344, the controller 105 can signal the haptic controller 160 to initiate a call prohibited profile. Continuing to step 346, the haptic controller can initiate a haptic response that signals to the user that the call has been prohibited. For example, the haptic controller can propagate signals to the force feedback amplifier that causes the PTT button 150 to vibrate continuously for a period of time.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically, i.e. communicatively linked through a communication channel or pathway. The term “directly connected,” as used herein, is defined as being connected such that electrical signals and/or mechanical forces are transferred without being significantly changed (i.e. degraded, weakened, amplified, phase shifted or time shifted).

This invention can be embodied in other forms without departing from the spirit or essential attributes thereof Accordingly, reference should be made to the following claims, rather than to the foregoing specification, as indicating the scope of the invention.

What is claimed is:

1. A mobile station, comprising:
a push-to-talk (PTT) button; and
a haptic response system directly connected to the PTT button.

2. The mobile station of claim 1, wherein the haptic response system comprises a positional actuator.

3. The mobile station of claim 2, wherein the haptic response system further comprises a haptic controller operatively coupled to the positional actuator.

4. The mobile station of claim 3, wherein the haptic response system further comprises a force feedback amplifier operatively coupled between haptic controller and the positional actuator.

5. The mobile station of claim 1, wherein the haptic response system comprises a vibration generator.

6. The mobile station of claim 5, wherein the haptic response system further comprises a haptic controller operatively coupled to the vibration generator.

7. The mobile station of claim 6, wherein the haptic response system further comprises a vibration amplifier operatively coupled between haptic controller and the vibration generator.

8. The mobile station of claim 1, further comprising a touch sensor integrated into the PTT button, the touch sensor signaling the mobile station to disable audible status tones in response to detecting an appendage in contact with the PTT button.

9. The mobile station of claim 1, further comprising a touch sensor integrated into the PTT button, the touch sensor signaling the mobile station to disable the haptic response system in response to detecting that an appendage is not in contact with the PTT button.

10. The mobile station of claim 1, further comprising:
an indicator lamp integrated into the PTT button.

11. The mobile station of claim 10, further comprising an indicator lamp driver operatively coupled to the indicator lamp.

12. The mobile station of claim 11, wherein the indicator lamp driver is operatively coupled between the indicator lamp and the haptic response system.

13. A mobile station, comprising:
a push-to-talk (PTT) button; and
a haptic response system directly connected to the PTT button, the haptic response system comprising:
a positional actuator;
a vibration generator; and
a haptic controller operatively coupled to the positional actuator and the vibration generator.

14. The mobile station of claim 13, further comprising a touch sensor integrated into the PTT button, the touch sensor signaling the mobile station to disable audible status tones in response to detecting an appendage in contact with the PTT button.

15. The mobile station of claim 13, further comprising an indicator lamp integrated into the PTT button.

16. A method for indicating a status of a mobile station comprising:
receiving a response to a dispatch call request; and
generating a haptic stimulus via a PTT button that correlates to the received response.

17. The method of claim 16, wherein generating the haptic stimulus comprises applying a translational force to the PTT button.

18. The method of claim 16, wherein generating the haptic stimulus comprises vibrating the PTT button.

19. The method of claim 16, further comprising disabling mobile station audible status tones in response to detecting an appendage in contact with the PTT button.

20. The method of claim 16, further comprising disabling the haptic stimulus in response to detecting that an appendage is not in contact with the PTT button.
